(19) United States
(12) Patent Application Publication
(10) Pub. No.: US 2024/0184116 A1
(43) Pub. Date: Jun. 6, 2024

(54) Optical Systems for Mitigating Waveguide Non-Uniformity

(71) Applicant: Apple Inc., Cupertino, CA (US)

(72) Inventors: Di Hu, Mountain View, CA (US); Guolin Peng, Sunnyvale, CA (US); Vikrant Bhakta, Santa Clara, CA (US); Jose A Dominguez-Caballero, San Jose, CA (US); Hyungryul Choi, San Jose, CA (US)

(21) Appl. No.: 18/440,534

(22) Filed: Feb. 13, 2024

Related U.S. Application Data
(63) Continuation of application No. PCT/US2022/040814, filed on Aug. 18, 2022.
(60) Provisional application No. 63/240,111, filed on Sep. 2, 2021.

(51) Int. Cl. G02B 27/01

(52) U.S. Cl. CPC G02B 27/0172; G02B 2027/0118

(57) ABSTRACT

An electronic device may have a display system with a module that produces image light and a waveguide that directs the image light towards an eye box. The module may include a light source, spatial light modulator, and collimating lens between the lens and modulator. The lens may direct illumination from the light source to the modulator, which modulates the illumination to produce the image light. The lens may have a geometry that illuminates the modulator with a non-uniform illumination pattern to mitigate subsequent brightness non-uniformity introduced by the waveguide. The light source may include one or more LEDs that are independently driven by control circuitry over one or more drive lines to help mitigate the non-uniformity introduced by the waveguide and/or to operate the display in a heads-up display mode.

This application is a continuation of international patent application No. PCT/US2022/040814, filed Aug. 18, 2022, which claims priority to U.S. provisional patent application No. 63/240,111, filed Sep. 2, 2021, which are hereby incorporated by reference herein in their entireties.

### BACKGROUND

This disclosure relates generally to optical systems and, more particularly, to optical systems for electronic devices with displays.

Electronic devices often include displays that present images close to a user's eyes. For example, virtual and augmented reality headsets may include displays with optical elements that allow users to view the displays.

Devices such as these can be challenging to design. If care is not taken, the components used to display images in these devices can be unsightly and bulky and may not exhibit a desired optical performance. For example, the images presented to the user can exhibit non-uniform brightness due to the components.

### SUMMARY

An electronic device may have a display system. The display system may include a display module that produces image light. A waveguide may direct the image light towards an eye box. The display module may include a light source, a spatial light modulator, and a collimating lens optically interposed between the collimating lens and the spatial light modulator. The collimating lens may direct illumination light from the light source to the spatial light modulator. The spatial light modulator my modulate the illumination light using image data to produce the image light.

The waveguide may impart non-uniform brightness to the image light across a field of view of the eye box. The collimating lens may include a lens element that has a geometry selected to illuminate the spatial light modulator with a non-uniform brightness across a field of view of the spatial light modulator in a manner that mitigates the subsequent non-uniformity introduced by the waveguide. The lens element may include multiple lens segments having respective non-parallel optical axes, for example. If desired, the lens element may have a freeform curved surface that is configured to illuminate the spatial light modulator using the illumination light in this way.

The light source may include a light emitting diode (LED) substrate having one or more LEDs. The one or more LEDs may be independently driven by control circuitry. If desired, rows of conductive vias may couple one or more drive lines to the LEDs. The control circuitry may independently drive different rows of the conductive vias to change the current distribution across the LED substrate, thereby altering the brightness of the illumination light provided by the light source across the field of view of the spatial light modulator. This variation may be used to mitigate the non-uniformity imparted to the image light by the waveguide and/or to operate the display module in a power saving mode (e.g., a heads-up display mode) when virtual objects are only located in a peripheral region of the field of view of the eye box.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with optical couplers in accordance with some embodiments.

FIG. 3 is a top view of an illustrative display module having illumination optics with an illumination lens that mitigates non-uniformity introduced to image light by an optical system in accordance with some embodiments.

FIG. 4 is a diagram showing how a rotationally symmetric collimating lens in illumination optics may produce non-uniformities in images provided to an eye box by an optical system in accordance with some embodiments.

FIG. 5 is a diagram showing how an illustrative multi-segment collimating lens in illumination optics may generate a non-uniform illumination pattern that mitigates non-uniformities in images provided to an eye box by an optical system in accordance with some embodiments.

FIG. 6 is a diagram of an illustrative non-uniform illumination pattern that may be produced by a collimating lens in illumination optics to mitigate non-uniformities in images provided to an eye box by an optical system in accordance with some embodiments.

FIG. 7 is a diagram showing how an illustrative collimating lens in illumination optics may be configured to mitigate any pattern of non-uniformity in images provided to an eye box by an optical system in accordance with some embodiments.

FIG. 8 is a front view of an illustrative light source that may be controlled to mitigate non-uniformities in images provided to an eye box by an optical system and/or to minimize power consumption in accordance with some embodiments.

FIG. 9 is a rear view of an illustrative light source that includes multiple driving vias that may be independently driven in rows to mitigate non-uniformities in images provided to an eye box by an optical system and/or to minimize power consumption in accordance with some embodiments.

FIG. 10 is a front view of an illustrative light source having an array of light emitting elements that may be independently driven or that may be independently driven in rows to mitigate non-uniformities in images provided to an eye box by an optical system and/or to minimize power consumption in accordance with some embodiments.

FIG. 11 is a diagram of an illustrative field of view of light provided to an eye box that includes image data within a peripheral region of the field of view in accordance with some embodiments.

### DETAILED DESCRIPTION

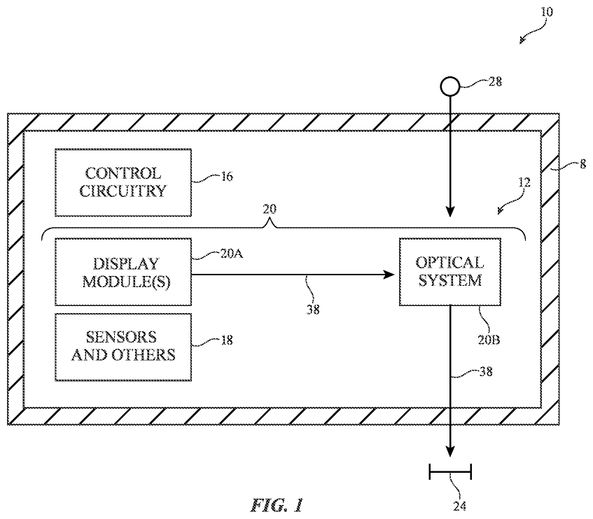

System 10 of FIG. 1 may be a head-mounted device having one or more displays. The displays in system 10 may include near-eye displays 20 mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B (sometimes referred to herein as optics 20B). Display modules 20A may be mounted in a support structure such as support structure 8. Each display module 20A may emit light 38 (image light) that is redirected towards a user's eyes at eye box 24 using an associated one of optical systems 20B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 20A may be liquid crystal displays, organic light-emitting diode displays, laser-based displays, or displays of other types. Display modules 20A may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light, etc.

Optical systems 20B may form lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain components (e.g., an optical combiner, etc.) to allow real-world image light from real-world images or objects (e.g., objects 28) to be combined optically with virtual (computer-generated) images such as virtual images in image light 38. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of external objects and this content is digitally merged with virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

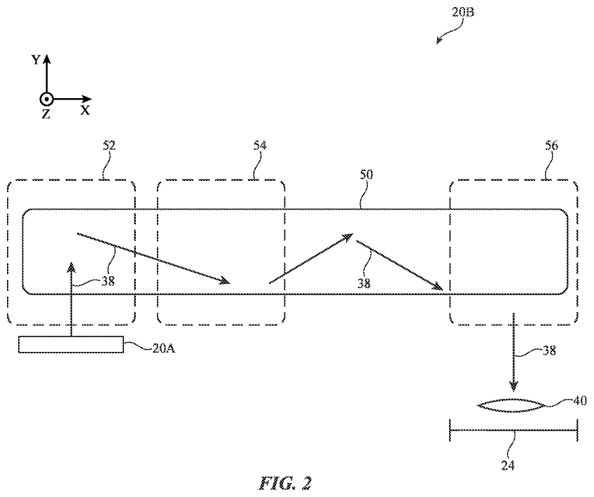

FIG. 2 is a top view of an illustrative display 20 that may be used in system 10 of FIG. 1. As shown in FIG. 2, near-eye display 20 may include one or more display modules such as display module(s) 20A and an optical system such as optical system 20B. Optical system 20B may include optical elements such as one or more waveguides 50. Waveguide 50 may include one or more stacked substrates (e.g., stacked planar and/or curved layers sometimes referred to herein as waveguide substrates) of optically transparent material such as plastic, polymer, glass, etc.

If desired, waveguide 50 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 50 may include holographic phase gratings such as volume holograms or thin-film holograms, meta-gratings, or any other desired diffractive grating structures. The diffractive gratings on waveguide 50 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 50 if desired.

As shown in FIG. 2, display module 20A may generate image light 38 associated with image content to be displayed to eye box 24 (e.g., image light 38 may convey a series of image frames for display at eye box 24). Image light 38 may be collimated using a collimating lens if desired. Optical system 20B may be used to present image light 38 output from display module 20A to eye box 24. If desired, display module 20A may be mounted within support structure 8 of FIG. 1 while optical system 20B may be mounted between portions of support structure 8 (e.g., to form a lens that aligns with eye box 24). Other mounting arrangements may be used, if desired.

Optical system 20B may include one or more optical couplers (e.g., light redirecting elements) such as input coupler 52, cross-coupler 54, and output coupler 56. In the example of FIG. 2, input coupler 52, cross-coupler 54, and output coupler 56 are formed at or on waveguide 50. Input coupler 52, cross-coupler 54, and/or output coupler 56 may be completely embedded within the substrate layers of waveguide 50, may be partially embedded within the substrate layers of waveguide 50, may be mounted to waveguide 50 (e.g., mounted to an exterior surface of waveguide 50), etc.

Waveguide 50 may guide image light 38 down its length via total internal reflection. Input coupler 52 may be configured to couple image light 38 from display module 20A into waveguide 50, whereas output coupler 56 may be configured to couple image light 38 from within waveguide 50 to the exterior of waveguide 50 and towards eye box 24. Input coupler 52 may include an input coupling prism, an edge or face of waveguide 50, a lens, a steering mirror or liquid crystal steering element, or any other desired input coupling elements. As an example, display module 20A may emit image light 38 in direction +Y towards optical system 20B. When image light 38 strikes input coupler 52, input coupler 52 may redirect image light 38 so that the light propagates within waveguide 50 via total internal reflection towards output coupler 56 (e.g., in direction +X within the total internal reflection (TIR) range of waveguide 50). When image light 38 strikes output coupler 56, output coupler 56 may redirect image light 38 out of waveguide 50 towards eye box 24 (e.g., back along the Y-axis). A lens such as lens 40 may help to direct or focus image light 38 onto eye box 24. Lens 40 may be omitted if desired. In scenarios where cross-coupler 54 is formed on waveguide 50, cross-coupler 54 may redirect image light 38 in one or more directions as it propagates down the length of waveguide 50, for example. In redirecting image light 38, cross-coupler 54 may also perform pupil expansion on image light 38.

Input coupler 52, cross-coupler 54, and/or output coupler 56 may be based on reflective and refractive optics or may be based on diffractive (e.g., holographic) optics. In arrangements where couplers 52, 54, and 56 are formed from reflective and refractive optics, couplers 52, 54, and 56 may include one or more reflectors (e.g., an array of micromirrors, partial mirrors, louvered mirrors, or other reflectors). In arrangements where couplers 52, 54, and 56 are based on diffractive optics, couplers 52, 54, and 56 may include diffractive gratings (e.g., volume holograms, surface relief gratings, etc.).

The example of FIG. 2 is merely illustrative. Optical system 14B may include multiple waveguides that are laterally and/or vertically stacked with respect to each other. Each waveguide may include one, two, all, or none of couplers 52, 54, and 56. Waveguide 50 may be at least partially curved or bent if desired. One or more of couplers 52, 54, and 56 may be omitted. If desired, optical system 20B may include an optical coupler that performs the operations of both cross-coupler 54 and output coupler 56 (sometimes referred to herein as an interleaved coupler, a diamond coupler, or a diamond expander).

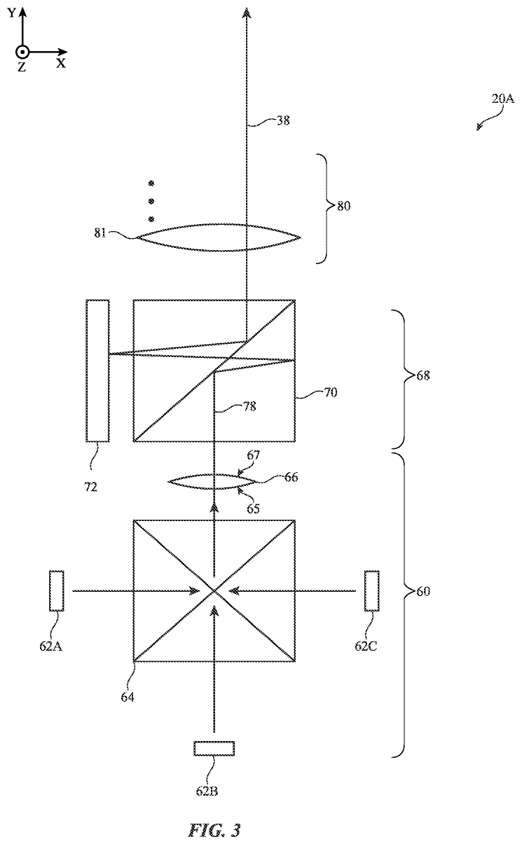

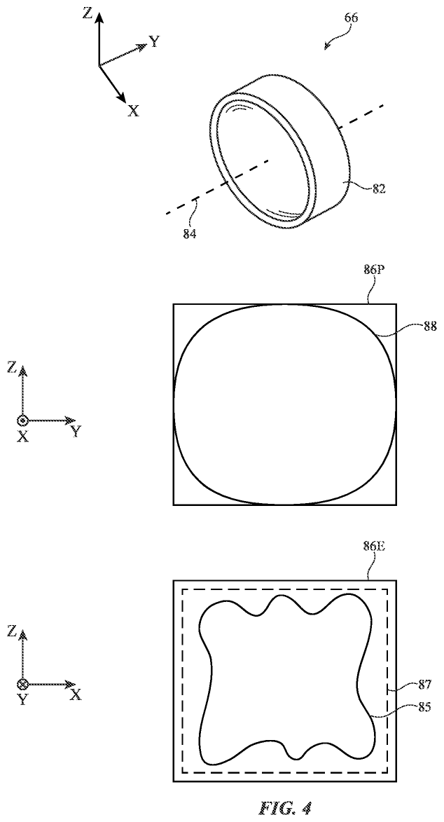

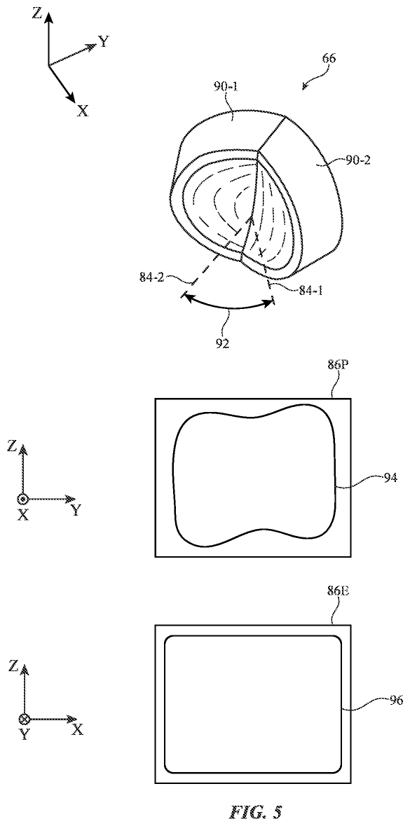

FIG. 3 is a top view of display module 20A in an example where display module 20A includes a reflective display panel. As shown in FIG. 3, display module 20A may include illumination optics 60 that provide illumination light 78 to spatial light modulator 68. Spatial light modulator 68 may modulate images using (onto) illumination light 38 to produce image light 38. Image light 38 may be directed towards input coupler 52 of waveguide 50 (FIG. 2) by collimating optics 80 (sometimes referred to herein as eyepiece optics 80 or eyepiece 80). Collimating optics 80 may include one or more lens elements 81. Each lens element 81 may have one or more concave surfaces, convex surfaces, spherical surfaces, aspherical surfaces, freeform curved surfaces (e.g., surfaces with curvature that follows any desired three-dimensional freeform curved path that is non-spherical, non-elliptical, etc.), etc. One or more lens elements 81 may impart optical power to image light 38 if desired.

Illumination optics 60 may include one or more light sources 62. Light sources 62 may include light emitting diodes (LEDs), organic light emitting diodes (OLEDs), micro LEDs (uLEDs), lasers, etc. Implementations in which light sources 62 are LED light sources is described herein as an example. Each light source 62 may emit illumination light of a corresponding wavelength band (color). For example, as shown in FIG. 3, illumination optics 60 may include a first light source 62A that emits illumination light of a first color (e.g., red illumination light), a second light source 62B that emits illumination light of a second color (e.g., green illumination light), and a third light source 62C that emits illumination light of a third color (e.g., blue illumination light). Each light source 62 may include a light emitter (e.g., an LED die or other light-emitting structure) and one or more lenses (e.g., Fresnel lenses) and/or microlenses that help to direct the illumination light in a desired direction. This example is merely illustrative. In general, each light source 62 may emit light of any desired color. Light source 62A may be replaced with an array of light sources, light source 62B may be replaced with an array of light sources, and/or light source 62C may be replaced with an array of light sources if desired. Illumination optics 60 may include more than three or fewer than three light sources 62 if desired.

Each light source 62 in illumination optics 60 may emit a respective portion of illumination light 78. Illumination optics 60 may include partially reflective structures such as X-plate 64 that combines the light emitted by each of the light sources 62 in illumination optics 60 into illumination light 78 (e.g., illumination light 78 may include red, green, and blue light emitted by the light sources 62A, 62B, and 62C). X-plate 64 may include a pair of partially reflective plates that reflect light of some wavelengths while transmitting light of other wavelengths, for example. If desired, X-plate 64 may be provided with optical wedges that help to support X-plate 64. X-plate 64 may, for example, be formed from coatings or layers on surfaces of the optical wedges. In scenarios where optical wedges are provided in illumination optics 60 for supporting X-plate 64, the X-plate and wedges may sometimes be referred to collectively as a prism (e.g., prism 64).

Illumination light 78 may include the illumination light generated by light source 62A (e.g., red light), the illumination light generated by light source 62B (e.g., green light), and/or the illumination light generated by light source 62C (e.g., blue light). X-plate 64 may provide illumination light 78 to spatial light modulator 68. Illumination optics 60 may include a collimating lens 66 that helps to focus and/or direct illumination light 78 onto a display panel in spatial modulator 68. Collimating lens 66 may include one or more lens elements. For example, as shown in FIG. 3, collimating lens 66 may include a lens element having a first surface 65 and an opposing second surface 67.

Spatial light modulator 68 may include prism 70 and a reflective display panel such as display panel 72. Display panel 72 may be a DMD panel, an LCOS panel, a ferroelectric liquid crystal on silicon (fLCOS) panel, or other reflective display panel. Prism 70 may direct illumination light 78 onto display panel 72 (e.g., different pixels on display panel 50). Control circuitry 16 (FIG. 1) may control display panel 72 to selectively reflect illumination light 78 at each pixel location to produce image light 38 (e.g., image light having an image as modulated using/onto the illumination light by display panel 72). Prism 70 may direct image light 38 toward collimating optics 80. The example of FIG. 3 in which display panel 72 is a reflective display panel is merely illustrative. If desired, display panel 72 may be a transmissive display panel that transmits and modulates the illumination light using image data to produce image light 38 (e.g., a transmissive liquid crystal display panel).

In an ideal system, collimating lens 66 is configured to illuminate as large an area on display panel 72 as possible with a uniform amount (intensity/luminance) of illumination light 78. This may allow display panel 72 to produce image light 38 with as uniform a peak brightness as possible across the field of view of the display. However, in practice, the optical components of optical system 20B (FIG. 2) may introduce non-uniformity to the brightness of the images in image light 38 while directing image light 38 to eye box 24. For example, transitions within waveguide 50, input coupler 52, cross-coupler 54, and/or output coupler 56 may redirect (e.g., refract or diffract) image light 38 within different portions of the field of view with different efficiencies. These non-uniformities may cause parts of the field of view at eye box 24 to appear more dimly or brightly illuminated than others.

FIG. 4 is a diagram showing how collimating lens 66 in illumination optics 60 may produce non-uniformities across the field of view at eye box 24 in an example where collimating lens 66 uniformly (symmetrically) illuminates display panel 72 with illumination light 78. As shown in FIG. 4, collimating lens 66 may include a lens element 82. Lens element 82 may have an optical axis 84. Lens element 82 may be rotationally symmetric about optical axis 84.

The rotational symmetry of lens element 82 may configure lens element 82 to uniformly and symmetrically illuminate the field of view 86P of display panel 72 with illumination light 78. For example, as shown in FIG. 4, lens element 82 may provide illumination light 78 to display panel 72 with peak brightness within a uniform and symmetric region 88 of field of view 86P. Region 88 may, for example, correspond to a region of the field of view in which the illumination light is provided at a brightness level that is within a fixed percentage (e.g., 0.5%, 1%, 2%, 5%, etc.) of the peak brightness of illumination light 78.

Display panel 72 may reflect the illumination light from lens element 82 as image light 38. As image light 38 propagates through optical system 20B, non-uniformities in optical system 20B may distort the uniformity and the symmetry of the brightness of the image light across the field of view by the time the image light reaches eye box 24. This may cause image light 38 to exhibit peak brightness within non-uniform (asymmetric) region 85 of the field of view 86E at eye box 24, rather than exhibiting the peak brightness across an ideal uniform region 87 of field of view 86E. Regions 85 and 87 may, for example, correspond to a region of the field of view in which the illumination light is provided at a brightness level that is within a fixed percentage (e.g., 0.5%, 1%, 2%, 5%, etc.) of the peak brightness of image light 38.

To mitigate these non-uniformities introduced to image light 38 by optical system 20B, collimating lens 66 in illumination optics 60 may be configured to illuminate display panel 72 with a non-uniform, asymmetric, distorted, and/or modified pattern of illumination light 78 that mitigates (e.g., reverses, cancels out, corrects, or pre-compensates for) the non-uniformities introduced to image light 38 by optical system 20B. FIG. 5 is a diagram showing one example of how collimating lens use illumination light 78 to mitigate the non-uniformities introduced to image light 38 by optical system 20B.

As shown in FIG. 5, collimating lens 66 may include a lens element that is not rotationally symmetric about a single optical axis. For example, collimating lens 66 may be a multi-segment or multi-element lens that includes multiple lens segments 90 that are coupled together such as a first lens segment 90-1 and a second lens segment 90-2 (e.g., collimating lens 66 may be a dual-segment or dual-tilted lens element). The lens segments 90 in collimating lens 66 may be coupled together using optically clear adhesive or other attachment structures (e.g., where each lens segment 90 is separately cut, molded, ground, shaped, etched, and/or polished and then adhered or attached together) or may be formed from different respective portions of the same integral lens element (e.g., where the lens element is molded, shaped, cut, ground, etched, and/or polished from a single integral piece of optical material such as glass, crystal, or plastic).

If desired, each lens segment 90 may be rotationally symmetric about a respective optical axis 84 (e.g., partially rotationally symmetric such that the lens segment exhibits rotational symmetry about its optical axis 84 up to the point, line, or surface where the lens segment 90 intersects with one or more other lens segments 90). For example, lens segment 90-1 may be rotationally symmetric about optical axis 84-1 whereas lens segment 90-2 is rotationally symmetric about optical axis 84-2. The optical axes of collimating lens 66 may be parallel and/or may be non-parallel with respect to each other. For example, optical axis 84-1 may be tilted at angle 92 with respect to optical axis 84-2. Angle 92 may be 20 degrees, 10-30 degrees, 15-25 degrees, 5-35 degrees, 5-45 degrees, less than 30 degrees, more than 10 degrees, or other angles, as examples.

When configured in this way, collimating lens 66 may non-uniformly illuminate the field of view 86P of display panel 72 using illumination light 78 (e.g., without rotational symmetry). For example, as shown in FIG. 5, lens segments 90-1 and 90-2 may provide illumination light 78 to display panel 72 with peak brightness within a non-uniform region 94 of field of view 86P. Region 94 may, for example, have different peak regions corresponding to each optical axis or lens segment of collimating lens 66 (e.g., each lens segment 90 may focus illumination light onto respective portions of field of view 86P). Region 94 may, for example, correspond to a region of the field of view in which the illumination light is provided at a brightness level that is within a fixed percentage (e.g., 0.5%, 1%, 2%, 5%, etc.) of the peak brightness of illumination light 78.

Display panel 72 may reflect the illumination light from lens segments 90 as image light 38. By reflecting illumination light 78 as image light 38, display panel 72 may impart image light 38 with a brightness profile corresponding to the profile of illumination light 78 (e.g., as shown by region 94). When image light 38 propagates through optical system 20B, non-uniformities in optical system 20B may distort the uniformity and the symmetry of the brightness of the image light across the field of view by the time the image light reaches eye box 24 (e.g., as shown by region 85 of FIG. 4). The non-uniform illumination pattern produced by the lens segments 90 of collimating lens 66 (e.g., as shown by region 94 of FIG. 5) on display panel 72 may serve to pre-compensate image light 38 for the non-uniformity subsequently introduced by optical system 20B. In other words, optical system 20B, in introducing non-uniformity to the brightness of image light 38 (e.g., as shown by region 85 of FIG. 4), may reverse or cancel out the non-uniformity of image light 38 produced by the non-uniform illumination of display panel 72 by collimating lens 66, thereby filling eye box 24 with image light 38 having uniform brightness across field of view 86E (e.g., as shown by ideal peak brightness region 96 of FIG. 5). Regions 94 and 96 may, for example, correspond to a region of the field of view in which the illumination light is provided at a brightness level that is within a fixed percentage (e.g., 0.5%, 1%, 2%, 5%, etc.) of the peak brightness of image light 38.

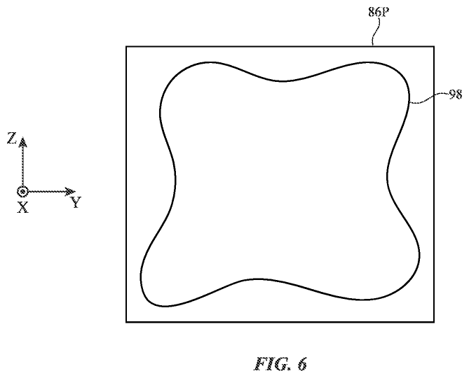

The example of FIG. 5 is merely illustrative. Collimating lens 66 may include any desired number of lens segments. For example, collimating lens 66 may include four lens segments 90 that are rotationally symmetric about four non-parallel optical axes 84. FIG. 6 shows one illustrative illumination pattern that may be produced on display panel 72 by a collimating lens 66 having four lens segments 90. As shown in FIG. 6, the collimating lens may illuminate the field of view 86P of display panel 72 with illumination light having peak brightness within region 98. Region 98 may have four lobes, portions, or subregions corresponding to the illumination light 78 directed (focused) by each of the four lens segments 90 in collimating lens 66, for example.

In general, collimating lens 66 need not include multiple lens segments 90 and may, if desired, include one or more lens elements having one or more surfaces (e.g., surfaces 65 and/or 67 of FIG. 3) that have a geometry configured to illuminate display panel 72 with non-uniform illumination light 78 in a manner that pre-compensates, mitigates, corrects, reverses, compensates for, or cancels out the non-uniformity subsequently (later) introduced to image light 38 by optical system 20B. The surface(s) of collimating lens 66 may be, for example, spherical, elliptical, planar, curved in two dimensions, curved in three dimensions, freeform curved, combinations of these, etc.

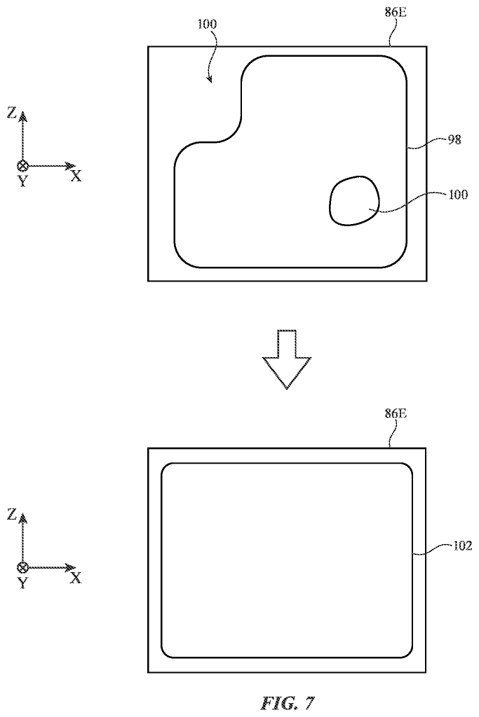

For example, as shown in FIG. 7, optical system 20B may impart non-uniformities to image light 38 produced using uniform illumination light 78 to produce one or more relatively bright regions 98 and one or more relatively dim regions 100 within the field of view 86E at eye box 24 (e.g., for image content having the same luminance value). The geometry of collimating lens 66 may be selected to provide display panel 72 with illumination light 78 in a non-uniform pattern that, after being used to form image light 38 and after the image light passes through optical system 20B, fills the field of view 86E at eye box with a uniform brightness (as shown by uniform region 102 of FIG. 7).

If desired, control circuitry 16 may additionally or alternatively adjust the image data provided to display panel 72 to help compensate for the non-uniformities introduced to image light 38 by optical system 20B (e.g., by performing image data reversals and/or gray level changes, etc.). Mitigating non-uniformities using collimating lens 66 may allow for display of brighter overall images at eye box 24 than in scenarios where only image data adjustment is used to mitigate the non-uniformities, for example.

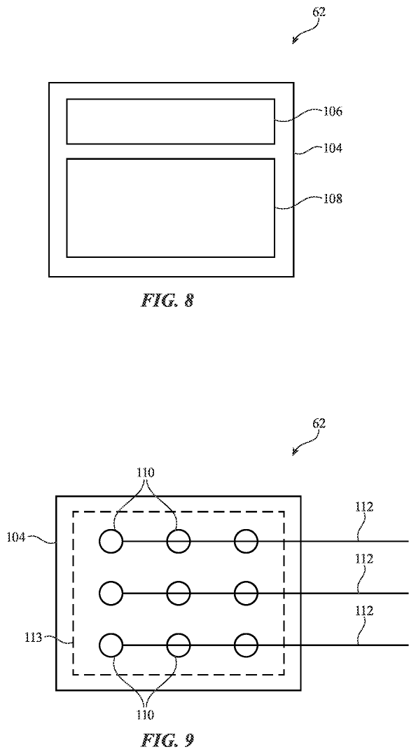

Additionally or alternatively, light sources 62 in illumination optics 60 may be adjusted to mitigate the non-uniformities imparted on image light 38 by optical system 20B. FIG. 8 is a diagram of a light source 62 that may be adjusted to mitigate the non-uniformities imparted on image light 38 by optical system 20B.

As shown in FIG. 8, light source 62 may include a first light emitter 106 (sometimes referred to herein as light emitting region 106) and a second light emitter 108 (sometimes referred to herein as light emitting region 108). Light emitters 106 and 108 may be, for example, LEDs and may therefore sometimes be referred to herein as LEDs 106 and 108. LEDs 106 and 108 may be formed on a common substrate, package, or die such as substrate 104 (sometimes referred to herein package 104). There may be a gap between LEDs 106 and 108 on substrate 104. LEDs 106 and 108 may be separate or without a patterned sapphire substrate (PSS)-type layer or may include a common (shared) PSS-type layer.

When driven by control signals (e.g., current), LEDs 106 and 108 may emit illumination light (e.g., at the same wavelength(s)). LEDs 106 and 108 may be driven independently (e.g., the control circuitry may drive LED 106 to produce illumination light without concurrently driving LED 108 or vice versa and/or the control circuitry may apply different drive signals to each LED at any given time to drive the LEDs using different amounts of current). If desired, LED 108 may emit more light than LED 106 (e.g., LED 108 may occupy a larger area on substrate 104 than LED 106). Control circuitry 16 (FIG. 1) may independently drive LEDs 106 and 108 to vary the brightness of illumination light 78 provided across the lateral area of display panel 72 in a manner that mitigates, pre-compensates for, corrects, cancels out, or reverses the non-uniformity produced in image light 38 by optical system 20B.

FIG. 9 is a rear view showing one example of how light source 62 may be driven. As shown in FIG. 9, light source 62 may include one or more light emitting regions (LEDs) 113 (e.g., a single large LED or multiple LEDs of different sizes such as LEDs 106 and 108 of FIG. 8). LED 113 may have a common PSS-type layer. Conductive vias 110 (e.g., UX-3 type hidden vias) may be cut, filled, and patterned on substrate 104 to couple LED 113 to two or more rows of drive lines 112. Each conductive via 110 may be coupled to a respective electrode for LED 113. Conductive vias 110 may, for example, be arranged in a grid pattern of rows and columns.

Control circuitry 16 may independently and separately drive control signals on each drive line 112 to separately and independently drive each row of conductive vias 110 and thus each row of electrodes on LED 113. In addition, when driven using drive lines 112, there may be slightly more charge density where the drive lines first connect to the LED (e.g., at the right side of substrate 104 in FIG. 1) than at the opposing side of the LED (e.g., at the left side of substrate 104 in FIG. 1). Control circuitry 16 may take advantage of this charge distribution, in combination with independently driving different drive lines 112 with different drive signals or currents, to vary the current density on LED 113 across its area (e.g., by non-uniformly spreading of the current density across LED 113). This may cause different regions on LED 113 to emit more illumination light 78 than others, allowing control circuitry 16 to vary the brightness of illumination light 78 provided across the lateral area of display panel 72 in a manner that mitigates, pre-compensates for, corrects, cancels out, or reverses the non-uniformity produced in image light 38 by optical system 20B.

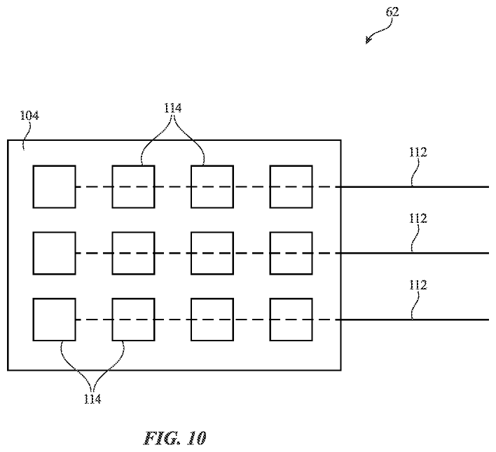

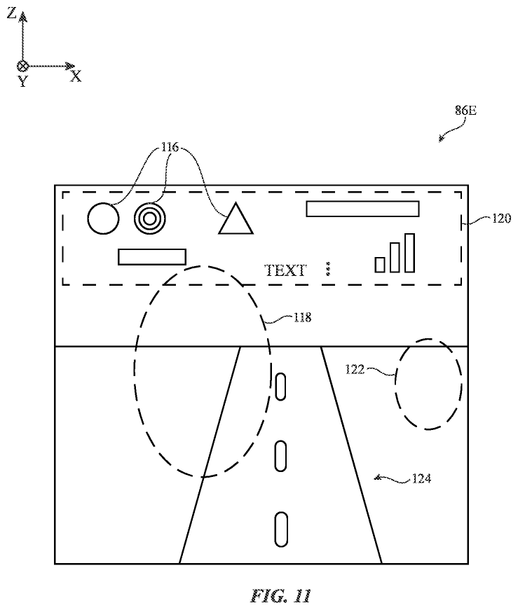

The example of FIG. 9 in which there is a single LED 113 on substrate 104 is merely illustrative. If desired, there may be an N-by-M array of LEDs 114 on substrate 104, as shown in FIG. 10. As shown in FIG. 10, each row of LEDs 114 may be driven by a corresponding drive line 112 (e.g., where each LED 114 has a respective electrode and conductive via coupled to its drive line 112). The LEDs 114 may be separated by gaps. There may be a common PSS-type layer shared by each of the LEDs if desired. Drive lines 112 may be driven independently to vary the amount of illumination light produced by each row of LEDs 114. Control circuitry 16 may independently drive each drive line 112 to vary the brightness of illumination light 78 provided across the lateral area of display panel 72 in a manner that mitigates, pre-compensates for, corrects, cancels out, or reverses the non-uniformity produced in image light 38 by optical system 20B.

The example of FIG. 10 is merely illustrative. In another implementation, shared drive lines 112 may be omitted. In these examples, each LED 114 may be independently driven by control circuitry 16 (e.g., each LED 114 may be coupled to a respective drive line by a respective electrode and conductive via). Independently driving each LED 114 may allow control circuitry 16 to perform two-dimensional local dimming of the illumination light 78 provided to display panel 72. This may conserve power and may also allow control circuitry to vary the brightness of illumination light 78 provided across the lateral area of display panel 72 in a manner that mitigates, pre-compensates for, corrects, cancels out, or reverses the non-uniformity produced in image light 38 by optical system 20B.

Additionally or alternatively, control circuitry 16 may drive the LEDs of FIGS. 8-10 in different operating modes such as in a power saving mode. In the power saving mode, sometimes referred to herein as a heads-up display (HUD) mode, the LEDs may be driven in a manner that produces less overall illumination light when only a relatively small part of the field of view is provided with virtual objects in illumination light 38 (e.g., virtual objects overlaid with real world objects in world light transmitted through waveguide 50).

FIG. 11 is a diagram of an exemplary field of view at eye box 24 when provided with both world light and image light 38. As shown in FIG. 11, eye box 24 may have an associated field of view 86E. Field of view 86E may include real-world objects 124 as conveyed by the world light (e.g., objects 28 of FIG. 1). In the example of FIG. 11, real-world objects 124 include a roadway or pathway in front of the user for the sake of illustration. This is merely illustrative and, in general, real-world objects 124 may include any desired real-world objects.

Image light 38 may convey virtual objects within field of view 86E (e.g., virtual objects that are overlaid with real-world objects 124 by the optical combiner formed from waveguide 50 of FIG. 2). The virtual objects may include relatively small virtual objects confined to a peripheral region of field of view 86E such as peripheral region 120. Peripheral region 120 may extend along the top peripheral edge of field of view 86E (as shown in FIG. 11), may extend along the right peripheral edge of field of view 86E, may extend along the left peripheral edge of field of view 86E, and/or may extend along the bottom peripheral edge of field of view 86E. Peripheral region 86E may occupy less than half of (e.g., less than 40% of, less than 30% of, less than 25% of, less than 20% of, less than 15% of, less than 10%, less than 5% of, etc.) the total area of field of view 86E.

As shown in FIG. 11, the relatively small virtual objects in peripheral region 120 may include graphical elements such as graphical elements 116. As examples, graphical elements 116 may include visual icons, text-based messages or information, status indicators (e.g., a battery level indicator for system 10, a wireless signal strength indicator, a temperature indicator, a clock, an elapsed time indicator such as a visual timer, a geographic location indicator such as an indicator that identifies a geographic location of system 10, a speed indicator such as a speedometer, a step indicator, etc.), direction indicators (e.g., navigation direction indicators, compass information, orientation information, etc.), alerts (e.g., traffic alerts, hazard alerts that identify or highlight potentially hazardous real-world objects 124 in front of system 10, news alerts, etc.), notifications (e.g., text message notifications, email notifications, application notifications, etc.), photos, videos, health information (e.g., a pulse meter indicator, a blood oxygen indicator, etc.), website information, graphical elements associated with applications running on system 10, or any other graphic and/or text-based elements provided within peripheral region 120.

Because graphical elements 116 are relatively small compared to the total area of field of view 86E, graphical elements 116 may only require some of the total brightness producible by display module 20A to be clearly visible at eye box 24. In order to minimize power consumption in system 10, when the image data to be conveyed by image light 38 includes only graphical elements 116, control circuitry 16 may control illumination optics 60 (FIG. 3) to produce illumination light 38 using only some of the LEDs in each light source 62 (e.g., using LED 106 but not LED 108 of FIG. 8, using only some but not all of the LEDs 114 or some but not all of the rows of LEDs 114 of FIG. 10) or by driving only a portion of the LED on substrate 104 (e.g., LED 113 of FIG. 9).

However, when larger virtual objects are included in the image data or when virtual objects are included in the image data for display outside of peripheral region 120 (see, e.g., virtual objects that are confined entirely within the region of field of view 86E that is outside of peripheral region 120, such as virtual object 122 and/or virtual objects that are included in the image data for display both within and outside of peripheral region 120, such as virtual object 118), control circuitry 16 may control illumination optics 60 to produce illumination light 38 using more (e.g., all) of the LEDs on substrate 104 (e.g., using both LED 106 and LED 108 of FIG. 8, using all of the LEDs 114 or all of the rows of LEDs 114 of FIG. 10) or by driving all of the LED on substrate 104 (e.g., LED 113 of FIG. 9). This may ensure that the relatively large virtual objects and/or the virtual objects for display outside of peripheral region 120 are provided at eye box 24 with sufficient clarity.

In accordance with an embodiment, a display configured to display light is provided that includes a light source configured to emit illumination, a spatial light modulator configured to generate the light using the illumination, optics that include a waveguide configured to propagate the light via total internal reflection, and a lens optically interposed between the light source and the spatial light modulator, the lens is configured to mitigate a brightness non-uniformity imparted on the light by the optics by directing the illumination towards the spatial light modulator with a non-uniform brightness across a field of view of the spatial light modulator.

In accordance with another embodiment, the lens includes a first segment having a first optical axis, and a second segment on the first segment and having a second optical axis that is non-parallel with respect to the first optical axis.

In accordance with another embodiment, the second optical axis is tilted at a non-zero angle less than 30 degrees with respect to the first optical axis.

In accordance with another embodiment, the lens includes a third segment having a third optical axis that is non-parallel with respect to the first and second optical axes, and a fourth segment having a fourth optical axis that is non-parallel with respect to the first, second, and third optical axes.

In accordance with another embodiment, the lens has a freeform curved surface.

In accordance with another embodiment, the spatial light modulator includes a display panel selected from the group consisting of: a digital micromirror device (DMD) panel, a liquid crystal on silicon (LCOS) panel, a ferroelectric liquid crystal on silicon (fLCOS) panel, and a transmissive liquid crystal panel.

In accordance with another embodiment, the spatial light modulator is driven using image data that is modified across the field of view of the spatial light modulator to at least partially mitigate the brightness non-uniformity imparted on the light by the optics.

In accordance with another embodiment, the light source includes a light emitting diode (LED) substrate driven to at least partially mitigate the brightness non-uniformity imparted on the light by the optics.

In accordance with another embodiment, the LED substrate includes at least a first LED and a second LED and the light source is configured to at least partially mitigate the brightness non-uniformity imparted on the light by the optics by driving the first LED but not the second LED.

In accordance with another embodiment, the display includes at least first and second drive lines coupled to the LED substrate, the first and second drive lines are each coupled to one or more light emitting regions on the LED substrate over a respective plurality of conductive vias, and the first and second drive lines are independently driven to at least partially mitigate the brightness non-uniformity imparted on the light by the optics.

In accordance with another embodiment, the display includes an input coupler on the waveguide and configured to couple the light into the waveguide, and an output coupler on the waveguide and configured to couple the light out of the waveguide.

In accordance with an embodiment, a display is provided that includes a light source configured to emit illumination, a display panel configured to produce light by modulating the illumination using image data, a waveguide configured to propagate the light via total internal reflection, and a lens configured to direct the illumination from the light source towards the display panel, the lens includes a first segment having a first optical axis, and a second segment having a second optical axis that is tilted with respect to the first optical axis.

In accordance with another embodiment, the lens includes a third segment having a third optical axis that is tilted with respect to the first optical axis and with respect to the second optical axis.

In accordance with another embodiment, the lens includes a fourth segment having a fourth optical axis that is tilted with respect to the first optical axis, the second optical axis, and the third optical axis.

In accordance with another embodiment, the first segment is partially rotationally symmetric about the first optical axis and the second segment is partially rotationally symmetric about the second optical axis.

In accordance with another embodiment, the second optical axis is tilted at an angle between 5 degrees and 35 degrees with respect to the first optical axis.

In accordance with another embodiment, the display panel includes a display panel selected from the group consisting of: a digital micromirror device (DMD) panel, a liquid crystal on silicon (LCOS) panel, a ferroelectric liquid crystal on silicon (fLCOS) panel, and a transmissive liquid crystal panel.

In accordance with an embodiment, an optical system is provided that includes a light source configured to emit illumination, the light source includes a light emitting diode (LED) substrate, a first drive line coupled to a first portion of the LED substrate, and a second drive line coupled to a second portion of the LED substrate, the first and second portions of the LED substrate are configured to emit at least a portion of the illumination and the first portion of the LED substrate and the second portion of the LED substrate are independently driven using the first drive line and the second drive line, respectively; a display panel configured to produce light by modulating the illumination using image data, a lens configured to direct the illumination from the light source towards the display panel, and a waveguide configured to propagate the light via total internal reflection.

In accordance with another embodiment, the first drive line is coupled to the first portion of the LED substrate through a first row of conductive vias and the second drive line is coupled to the second portion of the LED substrate through a second row of conductive vias, the first row of conductive vias being driven using the first drive line without driving the second row of conductive vias using the second drive line.

In accordance with another embodiment, the optical system includes an LED on the LED substrate that includes both the first portion of the LED substrate and the second portion of the LED substrate.

In accordance with another embodiment, the optical system includes a first LED on the LED substrate that includes the first portion of the LED substrate and a second LED on the LED substrate that includes the second portion of the LED substrate.

In accordance with another embodiment, the optical system includes a first LED on the LED substrate that includes the first portion of the LED substrate; a second LED on the LED substrate that includes the second portion of the LED substrate; a third LED on the LED substrate that includes a third portion of the LED substrate that is driven by the first drive line; and a fourth LED on the LED substrate that includes a fourth portion of the LED substrate that is driven by the second drive line.

In accordance with another embodiment, the first portion of the LED is driven but not the second portion of the LED substrate when the light includes a first virtual object confined to a peripheral portion of a field of view of the display panel and the first and second portions of the LED substrate are both driven when the light includes a second virtual object that at least partially overlaps an area of the field of view outside of the peripheral portion.

In accordance with another embodiment, the first and second drive lines are configured to be independently driven to at least partially mitigate a brightness non-uniformity imparted on the light by the waveguide.

The foregoing is merely illustrative and various modifications can be made to the described embodiments. The foregoing embodiments may be implemented individually or in any combination.

What is claimed is:

1. An display configured to display light, comprising:
a light source configured to emit illumination;
a spatial light modulator configured to generate the light using the illumination;
optics that include a waveguide configured to propagate the light via total internal reflection; and
a lens optically interposed between the light source and the spatial light modulator, wherein the lens is configured to mitigate a brightness non-uniformity imparted on the light by the optics by directing the illumination towards the spatial light modulator with a non-uniform brightness across a field of view of the spatial light modulator.

2. The display of claim 1, wherein the lens comprises:
a first segment having a first optical axis; and
a second segment on the first segment and having a second optical axis that is non-parallel with respect to the first optical axis.

3. The display of claim 2, wherein the second optical axis is tilted at a non-zero angle less than 30 degrees with respect to the first optical axis.

4. The display of claim 2, wherein the lens further comprises:
a third segment having a third optical axis that is non-parallel with respect to the first and second optical axes; and
a fourth segment having a fourth optical axis that is non-parallel with respect to the first, second, and third optical axes.

5. The display of claim 1 wherein the lens has a freeform curved surface.

6. The display of claim 1, wherein the spatial light modulator comprises a display panel selected from the group consisting of: a digital micromirror device (DMD) panel, a liquid crystal on silicon (LCOS) panel, a ferroelectric liquid crystal on silicon (fLCOS) panel, and a transmissive liquid crystal panel.

7. The display of claim 1, wherein the spatial light modulator is driven using image data that is modified across the field of view of the spatial light modulator to at least partially mitigate the brightness non-uniformity imparted on the light by the optics.

8. The display of claim 1, wherein the light source comprises a light emitting diode (LED) substrate driven to at least partially mitigate the brightness non-uniformity imparted on the light by the optics.

9. The display of claim 8, wherein the LED substrate comprises at least a first LED and a second LED and wherein the light source is configured to at least partially mitigate the brightness non-uniformity imparted on the light by the optics by driving the first LED but not the second LED.

10. The display of claim 8, further comprising at least first and second drive lines coupled to the LED substrate, wherein the first and second drive lines are each coupled to one or more light emitting regions on the LED substrate over a respective plurality of conductive vias, and wherein the first and second drive lines are independently driven to at least partially mitigate the brightness non-uniformity imparted on the light by the optics.

11. The display of claim 1, further comprising:
an input coupler on the waveguide and configured to couple the light into the waveguide; and
an output coupler on the waveguide and configured to couple the light out of the waveguide.

12. A display comprising:
a light source configured to emit illumination;
a display panel configured to produce light by modulating the illumination using image data;
a waveguide configured to propagate the light via total internal reflection; and
a lens configured to direct the illumination from the light source towards the display panel, wherein the lens comprises:
a first segment having a first optical axis, and
a second segment having a second optical axis that is tilted with respect to the first optical axis.

13. The display of claim 12, wherein the lens further comprises:
a third segment having a third optical axis that is tilted with respect to the first optical axis and with respect to the second optical axis.

14. The display of claim 13, wherein the lens further comprises:
a fourth segment having a fourth optical axis that is tilted with respect to the first optical axis, the second optical axis, and the third optical axis.

15. The display of claim 12, wherein the first segment is partially rotationally symmetric about the first optical axis and wherein the second segment is partially rotationally symmetric about the second optical axis.

16. The display of claim 12, wherein the second optical axis is tilted at an angle between 5 degrees and 35 degrees with respect to the first optical axis.

17. The display of claim 12, wherein the display panel comprises a display panel selected from the group consisting of: a digital micromirror device (DMD) panel, a liquid crystal on silicon (LCOS) panel, a ferroelectric liquid crystal on silicon (fLCOS) panel, and a transmissive liquid crystal panel.

18. An optical system comprising:
a light source configured to emit illumination, wherein the light source includes
a light emitting diode (LED) substrate,
a first drive line coupled to a first portion of the LED substrate, and
a second drive line coupled to a second portion of the LED substrate, wherein the first and second portions of the LED substrate are configured to emit at least a portion of the illumination and the first portion of the LED substrate and the second portion of the LED substrate are independently driven using the first drive line and the second drive line, respectively;
a display panel configured to produce light by modulating the illumination using image data;
a lens configured to direct the illumination from the light source towards the display panel; and
a waveguide configured to propagate the light via total internal reflection.

19. The optical system of claim 18, wherein the first drive line is coupled to the first portion of the LED substrate through a first row of conductive vias and the second drive line is coupled to the second portion of the LED substrate through a second row of conductive vias, the first row of conductive vias being driven using the first drive line without driving the second row of conductive vias using the second drive line.

20. The optical system of claim 19, further comprising an LED on the LED substrate that includes both the first portion of the LED substrate and the second portion of the LED substrate.

21. The optical system of claim 19, further comprising a first LED on the LED substrate that includes the first portion of the LED substrate and a second LED on the LED substrate that includes the second portion of the LED substrate.

22. The optical system of claim 18, further comprising:
a first LED on the LED substrate that includes the first portion of the LED substrate;
a second LED on the LED substrate that includes the second portion of the LED substrate;
a third LED on the LED substrate that includes a third portion of the LED substrate that is driven by the first drive line; and
a fourth LED on the LED substrate that includes a fourth portion of the LED substrate that is driven by the second drive line.

23. The optical system of claim 18, wherein the first portion of the LED is driven but not the second portion of the LED substrate when the light includes a first virtual object confined to a peripheral portion of a field of view of the display panel and wherein the first and second portions of the LED substrate are both driven when the light includes a second virtual object that at least partially overlaps an area of the field of view outside of the peripheral portion.

24. The optical system of claim 18, wherein the first and second drive lines are configured to be independently driven to at least partially mitigate a brightness non-uniformity imparted on the light by the waveguide.
